(19) United States
(12) Patent Application Publication
(10) Pub. No.: US 2018/0326731 A1
(43) Pub. Date: Nov. 15, 2018

(54) LIQUID EJECTING APPARATUS

(71) Applicant: SEIKO EPSON CORPORATION, Tokyo (JP)

(72) Inventors: Shigenori FUKASAWA, Shiojiri-shi (JP); Yasuaki HIRAI, Shiojiri-shi (JP); Yuta KOMATSU, Shiojiri-shi (JP); Seiji TOJO, Shiojiri-shi (JP)

(21) Appl. No.: 15/972,302

(22) Filed: May 7, 2018

(30) Foreign Application Priority Data
May 9, 2017 (JP) 2017-093010

(51) Int. Cl. B41J 2/165

(52) U.S. Cl. CPC B41J 2/16541; B41J 2/16523; B41J 2/16547

(57) ABSTRACT

A liquid ejecting apparatus includes: a wiping portion which wipes a nozzle forming surface by relatively moving in a main scanning direction with respect to a recording head; and a controller which moves at least one of the recording head and the wiping member. The controller selects and performs at least one of first wiping processing for wiping the nozzle forming surface until the wiping portion is separated from the nozzle forming surface in the main scanning direction, and second wiping processing for separating the wiping portion from the nozzle forming surface in a retracting direction different from the main scanning direction after wiping the nozzle forming surface until the wiping portion comes into contact with a defined position of the nozzle forming surface.

### BACKGROUND

### 1. Technical Field

The present invention relates to a liquid ejecting apparatus including a wiping portion which wipes a nozzle forming surface of a liquid ejecting head.

### 2. Related Art

As an example of a liquid ejecting apparatus, an ink jet type printer which performs printing on a medium, such as a paper sheet, by ejecting ink which is an example of a liquid from a nozzle of a liquid ejecting head is widely known. In such a printer, wiping of the nozzle forming surface is performed by relatively moving the wiping portion which is in contact with the nozzle forming surface with respect to the liquid ejecting head in a wiping direction which is a direction along the nozzle forming surface.

In JP-A-2007-152940, an example of a wiping method of a nozzle forming surface is described. In the wiping method, wiping of the nozzle forming surface is started by relatively moving the wiping portion in the wiping direction with respect to the liquid ejecting head. In addition, in a state where the wiping portion is in contact with the nozzle forming surface, the direction of the relative movement of the wiping portion is changed from the wiping direction to a direction substantially orthogonal to the nozzle forming surface. Accordingly, the wiping portion separates from the nozzle forming surface. Next, after the ink is removed from the wiping portion separated from the nozzle forming surface by a removing member, the wiping portion is again brought into contact with the nozzle forming surface. In addition, by relatively moving the wiping portion which is in contact with the nozzle forming surface again in the wiping direction, the wiping portion is separated from the nozzle forming surface in the wiping direction, and wiping is completed. Accordingly, it is possible to suppress scattering of ink from the wiping portion when the deflection of the wiping portion is eliminated by the separation from the nozzle forming surface as much as the amount of ink adhering to the wiping portion at the end of wiping becomes small.

For example, in a situation where the amount of ink adhering to the nozzle forming surface is small, even when the wiping portion is relatively moved in the wiping direction until passing through the nozzle forming surface, the amount of ink adhering to the wiping portion by wiping the nozzle forming surface is small. Therefore, when the wiping portion is separated from the nozzle forming surface in the wiping direction and the deflection of the wiping portion is eliminated, the amount of ink scattering from the wiping portion is small. In other words, the ink is unlikely to be scattered from the wiping portion at the end of wiping, without wiping the nozzle forming surface by the above-described wiping method.

However, in the printer described in JP-A-2007-152940, wiping of the nozzle forming surface is performed by the wiping method even in a situation where the amount of ink adhering to the nozzle forming surface is small. In this case, the time required for wiping the nozzle forming surface becomes unnecessarily long. In other words, it is not possible to wipe the nozzle forming surface according to the situation.

### SUMMARY

An advantage of some aspects of the invention is to provide a liquid ejecting apparatus which can wipe the nozzle forming surface according to the situation.

According to an aspect of the invention, there is provided a liquid ejecting apparatus including: a liquid ejecting head having a nozzle which ejects a liquid and a nozzle forming surface on which the nozzle is opened; a wiping portion which wipes the nozzle forming surface by relatively moving in a wiping direction which is a direction along the nozzle forming surface with respect to the liquid ejecting head; a moving device which moves at least one of the liquid ejecting head and the wiping portion; and a wiping controller which controls the moving device. The wiping controller selects and performs at least one of first wiping processing for operating the moving device so as to wipe the nozzle forming surface until the wiping portion is separated from the nozzle forming surface in the wiping direction, and second wiping processing for operating the moving device so as to separate the wiping portion from the nozzle forming surface in a retracting direction which is a direction different from the wiping direction after wiping the nozzle forming surface until the wiping portion comes into contact with the nozzle forming surface at a defined position.

### BRIEF DESCRIPTION OF THE DRAWINGS

The invention will be described with reference to the accompanying drawings, wherein like numbers reference like elements.

FIG. 1 is a schematic configuration view of a printer which is a liquid ejecting apparatus according to a first embodiment.

FIG. 2 is a perspective view of a maintenance device of the printer.

FIG. 3 is a perspective view of the maintenance device of the printer.

FIG. 4 is a block diagram illustrating a control configuration of the printer.

FIG. 5 is a flowchart illustrating a processing routine performed by a cleaning controller of the printer.

FIG. 6 is a flowchart illustrating a processing routine performed by a wiping controller of the printer.

FIG. 7 is an operation view illustrating an aspect in which a nozzle forming surface is wiped by first wiping processing.

FIG. 8 is an operation view illustrating an aspect in which the nozzle forming surface is wiped by the first wiping processing.

FIG. 9 is an operation view illustrating an aspect in which the nozzle forming surface is wiped by the first wiping processing.

FIG. 10 is an operation view illustrating an aspect in which the nozzle forming surface is wiped by second wiping processing.

FIG. 11 is an operation view illustrating an aspect in which the nozzle forming surface is wiped by the second wiping processing.

FIG. 12 is an operation view illustrating an aspect in which the nozzle forming surface is wiped by the second wiping processing.

FIG. 13 is an operation view illustrating an aspect in which the nozzle forming surface is wiped by the second wiping processing.

FIG. 14 is a schematic configuration view of a part of the printer which is a liquid ejecting apparatus according to a second embodiment.

FIG. 15 is an operation view illustrating an aspect in which the nozzle forming surface is wiped by the first wiping processing.

FIG. 16 is an operation view illustrating an aspect in which the nozzle forming surface is wiped by the first wiping processing.

FIG. 17 is an operation view illustrating an aspect in which the nozzle forming surface is wiped by the second wiping processing.

FIG. 18 is an operation view illustrating an aspect in which the nozzle forming surface is wiped by the second wiping processing.

FIG. 19 is an operation view illustrating an aspect in which the nozzle forming surface is wiped by the second wiping processing.

FIG. 20 is an operation view illustrating an aspect in which the nozzle forming surface is wiped by the second wiping processing.

FIG. 21 is a schematic view of a part of the printer which is a liquid ejecting apparatus according to another embodiment.

FIG. 22 is an operation view illustrating an aspect in which the nozzle forming surface is wiped in the printer which is a liquid ejecting apparatus according to still another embodiment.

FIG. 23 is an operation view illustrating an aspect in which the nozzle forming surface is wiped by the printer.

FIG. 24 is an operation view illustrating an aspect in which the nozzle forming surface is wiped by the printer.

### DESCRIPTION OF EXEMPLARY EMBODIMENTS

### First Embodiment

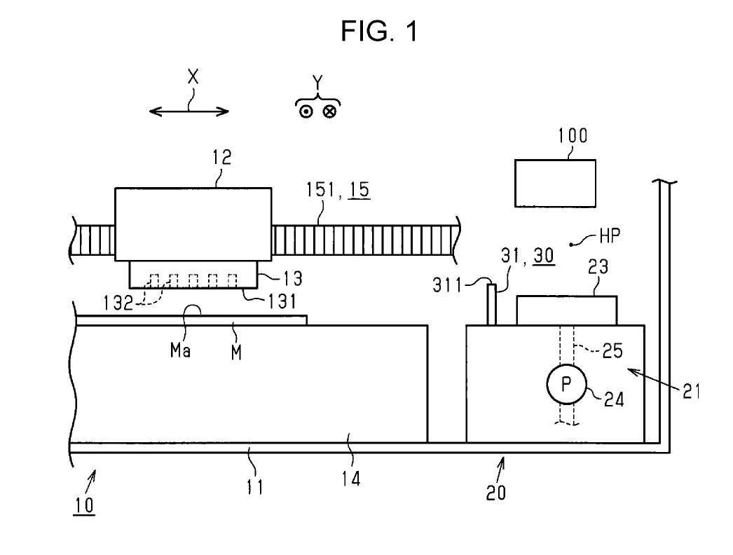

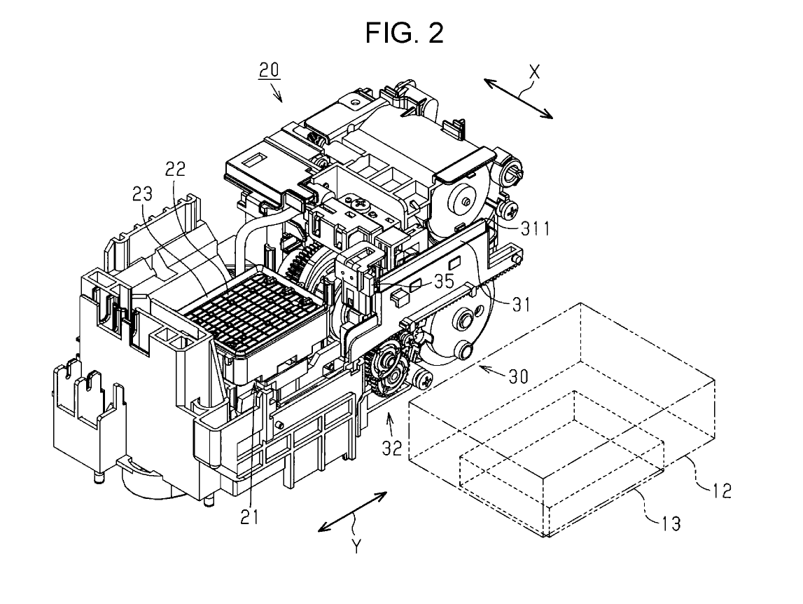

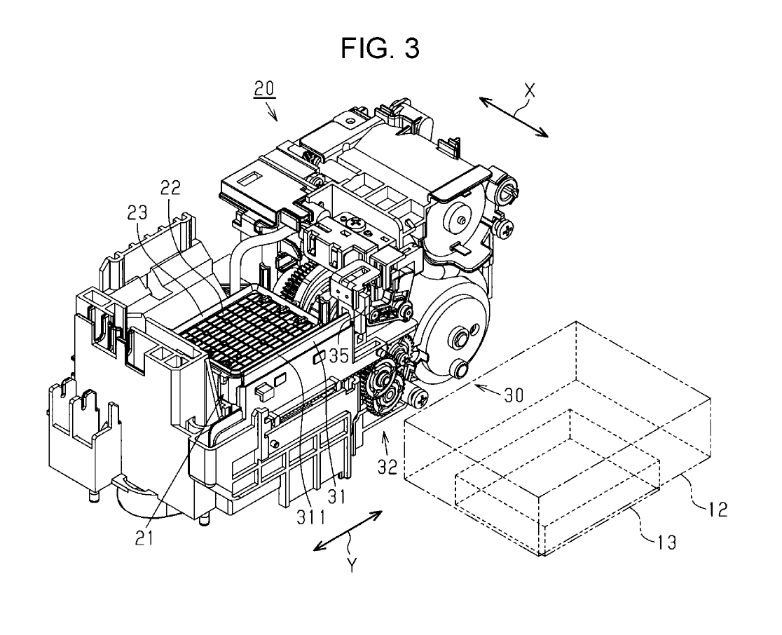

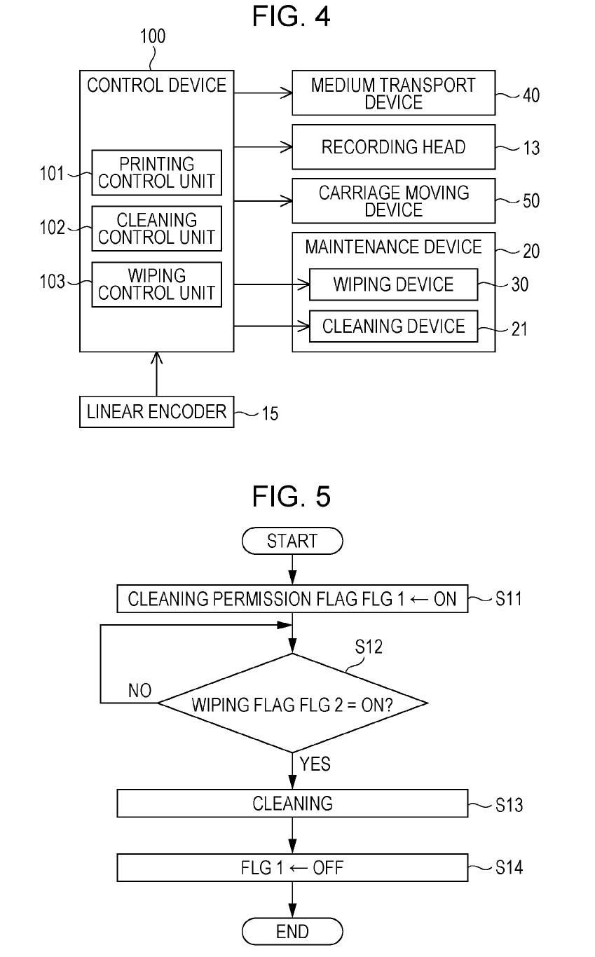

Hereinafter, a first embodiment of a liquid ejecting apparatus will be described with reference to FIGS. 1 to 13.

In FIG. 1, a part of a configuration in a housing 11 of an ink jet type printer 10 which is an example of the liquid ejecting apparatus of the embodiment is schematically illustrated. As illustrated in FIG. 1, in the housing 11, a carriage 12 which moves in a main scanning direction X which is a leftward-and-rightward direction in the drawing, and a recording head 13 which is an example of a liquid ejecting head mounted on the carriage 12, are provided. The recording head 13 includes: a nozzle forming surface 131 which opposes a printing surface Ma of a medium M when printing on a medium M, such as a paper sheet supported by a medium supporting portion 14; and a plurality of nozzles 132 which ejects ink which is an example of liquid. In the example illustrated in FIG. 1, a nozzle forming surface 131 is formed on the lower surface of the recording head 13 in the drawing. In addition, each of the nozzle 132 respectively is opened on the nozzle forming surface 131.

In addition, in the housing 11, a linear encoder 15 for detecting a position of the carriage 12 in the main scanning direction X is provided. The linear encoder 15 includes an elongated detection tape 151 disposed further on a far side than the carriage 12 in a direction orthogonal to the paper surface; and a detection system (not illustrated) provided in the carriage 12.

Furthermore, on the outside from the medium supporting portion 14 in the main scanning direction X, that is, on the right side from the medium supporting portion 14 in FIG. 1, a maintenance device 20 for performing various maintenance of the printer 10 is provided. Here, a region where the maintenance device 20 is disposed out of both regions positioned on the outside from the medium supporting portion 14 in the main scanning direction X is referred to as “home position HP”. Here, as the maintenance, for example, cleaning for forcibly discharging the ink from each of the nozzles 132 and wiping on a nozzle forming surface 131 can be employed.

As illustrated in FIGS. 1 to 3, the maintenance device 20 includes: a cap 23 in which a liquid absorbing member 22 is accommodated on the inside thereof; and a suction pump 24 which operates to generate a negative pressure in the cap 23. In other words, when cleaning, the suction pump 24 is operated in a state where a closed space is formed by the nozzle forming surface 131 of the recording head 13 and the cap 23. Then, the closed space becomes a negative pressure by the operation of the suction pump 24, and the ink is forcibly discharged from each of the nozzles 132 of the recording head 13 into the cap 23. In addition, the ink discharged into the cap 23 is discharged into a waste liquid tank (not illustrated) via a suction tube 25. Therefore, in the embodiment, cleaning corresponds to “liquid discharge processing” for discharging the ink from each of the nozzles 132 of the recording head 13. In addition, the cap 23, the suction pump 24, and the suction tube 25 configure a cleaning device 21 which is an example of “liquid discharge processing unit” used when cleaning (liquid discharge processing) is performed.

In addition, the maintenance device 20 is provided with a wiping device 30 used when wiping the nozzle forming surface 131. The wiping device 30 includes a wiping member 31 which is an example of a wiping portion disposed on the medium supporting portion 14 side in the main scanning direction X from the cap 23. The wiping member 31 is configured of a flexible material, such as a synthetic resin or rubber. Therefore, in a case where an upper end portion 311 of the wiping member 31 comes into contact with the nozzle forming surface 131, the wiping member 31 is deflected.

The wiping member 31 extends in a direction along the nozzle forming surface 131, that is, in a retracting direction Y which is a direction different from the main scanning direction X. In other words, the retracting direction Y is a direction different from the wiping direction (that is, the main scanning direction X) which is a direction in which the wiping member 31 relatively moves with respect to the recording head 13 when wiping the nozzle forming surface 131. In the embodiment, the retracting direction Y is orthogonal to the main scanning direction X. In addition, when the retracting direction Y is a direction along the nozzle forming surface 131, that is, a direction different from the main scanning direction X, the retracting direction Y may not be orthogonal to the main scanning direction X.

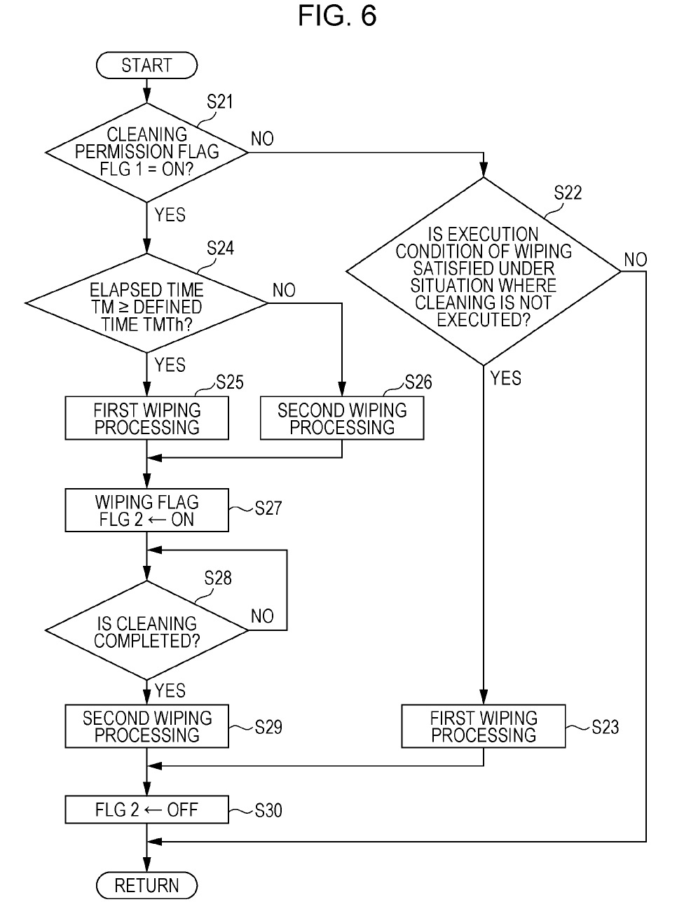

In addition, the wiping device 30 includes: an operating mechanism 32 for moving the wiping member 31 in the retracting direction Y which is also an extending direction of the wiping member 31; and a wiping motor (not illustrated) which is a power source of the operating mechanism 32. In other words, the wiping device 30 is one configuration element of an example of “moving device” which moves at least one of the recording head 13 and the wiping member 31. In the wiping device 30, by driving the wiping motor, it is possible to move the wiping member 31 between a wiping position illustrated in FIG. 3 and a retraction position illustrated in FIG. 2. The wiping position is a position where the upper end portion 311 of the wiping member 31 can be brought into contact with the nozzle forming surface 131 of the recording head 13 that moves in the main scanning direction X. Meanwhile, the retraction position is a position at which the upper end portion 311 of the wiping member 31 cannot be brought into contact with the nozzle forming surface 131, and in FIG. 1, for example, is set further on a near side of the paper surface than the recording head 13.

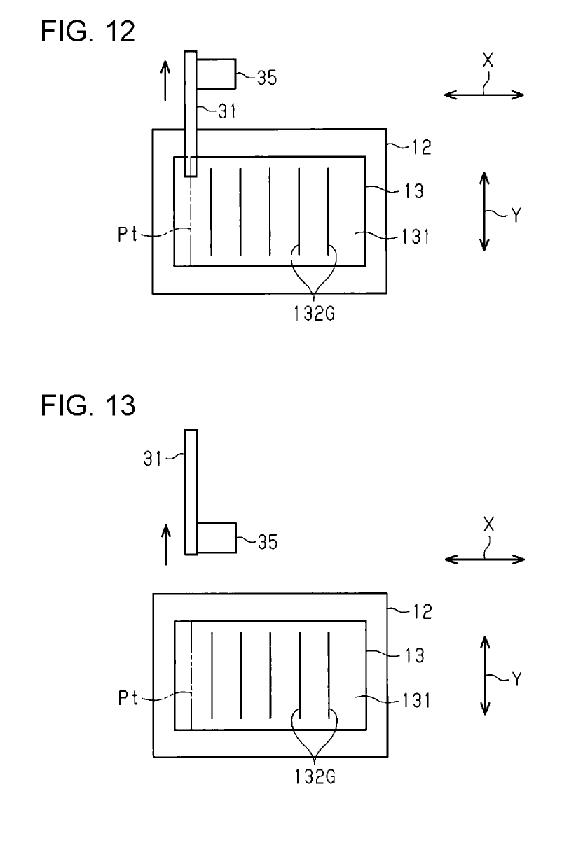

In addition, the wiping device 30 is provided with a removing member 35 which is an example of a removing unit that comes into contact with the wiping member 31 when the wiping member 31 is moved from the wiping position to the retraction position. For example, as illustrated in FIG. 11, when the wiping member 31 moves the wiping member 31 in the retracting direction Y toward the retraction position from the wiping position in a state where the wiping member 31 comes into contact with the nozzle forming surface 131, and as illustrated in FIG. 12, the wiping member 31 comes into contact with the removing member 35 before the wiping member 31 is separated from the nozzle forming surface 131. Specifically, a linear distance L1 between the recording head 13 disposed at a position at which the nozzle forming surface 131 can be wiped off and the removing member 35 is shorter than a length L2 in the retracting direction Y of the wiping member 31. In addition, by bringing the removing member 35 into contact with the wiping member 31 which moves in the retracting direction Y in this manner, it is possible to remove an adhering material, such as ink, from the wiping member 31.

Next, with reference to FIG. 4, a control configuration of the printer 10 will be described. As illustrated in FIG. 4, a control device 100 of the printer 10 includes a printing controller 101, a cleaning controller 102, and a wiping controller 103, as functional units.

When printing is performed on the medium M, the printing controller 101 controls the recording head 13, a medium transport device 40, and a carriage moving device 50. The medium transport device 40 is a device that operates to transport the medium M. The carriage moving device 50 is a device which operates to move the carriage 12 in the main scanning direction X. In other words, the carriage moving device 50 is one of the configuration elements of the “moving device”.

The cleaning controller 102 controls the carriage moving device 50 and the cleaning device 21 of the maintenance device 20 when cleaning is performed.

The wiping controller 103 controls the carriage moving device 50 and the wiping device 30 of the maintenance device 20 when wiping the nozzle forming surface 131.

In addition, when controlling the carriage moving device 50, each of the controllers 101 to 103 operates the carriage moving device 50 based on the position in the main scanning direction X of the carriage 12 detected based on a detection signal from the linear encoder 15.

Next, with reference to FIG. 5, a processing routine executed by the cleaning controller 102 will be described. The processing routine is a processing routine executed when the cleaning execution condition is satisfied. For example, when at least one of a case where the elapsed time after the last cleaning has is performed, the defined time or more, a case where the ink cartridge of the printer 10 is exchanged, and a case where a user of the printer 10 urges to perform the cleaning, is satisfied, the processing routine is executed assuming that the cleaning execution condition is satisfied.

As illustrated in FIG. 5, in the processing routine, the cleaning controller 102 sets a cleaning permission flag FLG 1 to ON (step S11). The cleaning permission flag FLG 1 is a flag in which ON is set so as to inform the wiping controller 103 that cleaning is to be performed. Next, the cleaning controller 102 determines whether ON is set to a wiping flag FLG 2 to be described later (step S12).

In addition, in a case where the wiping flag FLG 2 is set to OFF (step S12: NO), the cleaning controller 102 repeats the determination of step S12 until the wiping flag FLG 2 is set to ON. Meanwhile, in a case where the wiping flag FLG 2 is set to ON (step S12: YES), the cleaning controller 102 performs the cleaning (step S13). In other words, the cleaning controller 102 operates the carriage moving device 50 so that the recording head 13 is disposed at a position at which the cleaning can be performed. In addition, when the movement of the recording head 13 in the main scanning direction X is completed, the cleaning controller 102 operates the cleaning device 21 to bring the cap 23 into contact with the recording head 13, and in this state, the ink is forcibly discharged from each of the nozzles 132 in the cap 23.

When completing the cleaning, the cleaning controller 102 sets the cleaning permission flag FLG 1 to OFF (step S14). After this, the cleaning controller 102 ends the processing routine.

Next, with reference to FIG. 6, a processing routine executed by the wiping controller 103 will be described. In addition, the processing routine is executed each time a predetermined time has elapsed after the end of the execution of the previous processing routine.

As illustrated in FIG. 6, in the processing routine, it is determined that the wiping controller 103 sets the above-described cleaning permission flag FLG 1 to ON (step S21). In a case where the cleaning permission flag FLG 1 is set to ON, it can be determined that the wiping execution condition of the nozzle forming surface 131 is satisfied in accordance with the execution of cleaning. Meanwhile, in a case where the cleaning permission flag FLG 1 is set to OFF, it cannot be determined that the wiping execution condition of the nozzle forming surface 131 is satisfied in accordance with the execution of cleaning.

In addition, in a case where the cleaning permission flag FLG 1 is set to OFF (step S21: NO), the wiping controller 103 determines whether or not the wiping execution condition of the nozzle forming surface 131 is satisfied in a situation where the cleaning is not performed (Step S22). When performing the printing on the paper sheet as an example of the medium M, there is a concern that foreign matters, such as paper dust scattered from the paper sheet may adhere to the nozzle forming surface 131. Therefore, for example, in a case where the printing is continuously performed on a plurality of media M, and in a case where the printing on a predetermined number of media M is completed, it may be determined that the wiping execution condition of the nozzle forming surface 131 is satisfied. In addition, it is preferable that the predetermined number be a positive number (for example, 10) which is 2 or more.

In a case where the wiping execution condition is not satisfied (step S22: NO), the wiping controller 103 temporarily ends the processing routine. Meanwhile, in a case where the wiping execution condition is satisfied (step S22: YES), the wiping controller 103 executes first wiping processing (step S23) which will be described later. In addition, after the completion of the first wiping processing, the wiping controller 103 shifts the processing to step S30 which will be described later.

Meanwhile, in a case where the cleaning permission flag FLG 1 is set to ON (step S21: YES), the wiping controller 103 determines whether or not the elapsed time TM from the end of the previous cleaning execution is equal to or longer than a defined time TMTh (Step S24). The ink adhering to the nozzle forming surface 131 is volatilized with the lapse of time. In addition, when the volatilization progresses to some extent, it can be determined that the viscosity of the ink adhering to the nozzle forming surface 131 is high.

Here, in a case where the elapsed time TM is equal to or longer than the defined time TMTh (step S24: YES), it can be determined that the viscosity of the ink adhering to the nozzle forming surface 131 has increased, and thus, the wiping controller 103 selects and performs the first wiping processing (step S25). In addition, after the completion of the first wiping processing, the wiping controller 103 shifts the processing to step S27 which will be described later. Meanwhile, in a case where the elapsed time TM is less than the defined time TMTh (step S24: NO), it can be determined that the viscosity of the ink adhering to the nozzle forming surface 131 has not increased, and thus, the wiping controller 103 selects and performs second wiping processing different from the first wiping processing (step S26). The second wiping processing will also be described later. In addition, after the completion of the second wiping processing, the wiping controller 103 shifts the processing to step S27 which will be described later.

In step S27, the wiping controller 103 sets the wiping flag FLG2 to ON. In other words, in the embodiment, when cleaning is performed, the nozzle forming surface 131 is wiped before the cleaning is performed. In addition, while the wiping flag FLG 2 is a flag which is set to OFF when the wiping prior to cleaning is not completed, and which is set to ON when wiping prior to cleaning is completed. Next, the wiping controller 103 determines whether the cleaning by the cleaning controller 102 has been completed (step S28). For example, in a case where the cleaning permission flag FLG 1 is set to OFF, it can be determined that the cleaning execution has finished. In a case where the execution of the cleaning has not been completed yet (step S28: NO), the wiping controller 103 repeats the determination of step S28. Meanwhile, in a case where the cleaning is completed (step S28: YES), the wiping controller 103 executes the second wiping processing (step S29). After the completion of the second wiping processing, the wiping controller 103 shifts the processing to the next step S30.

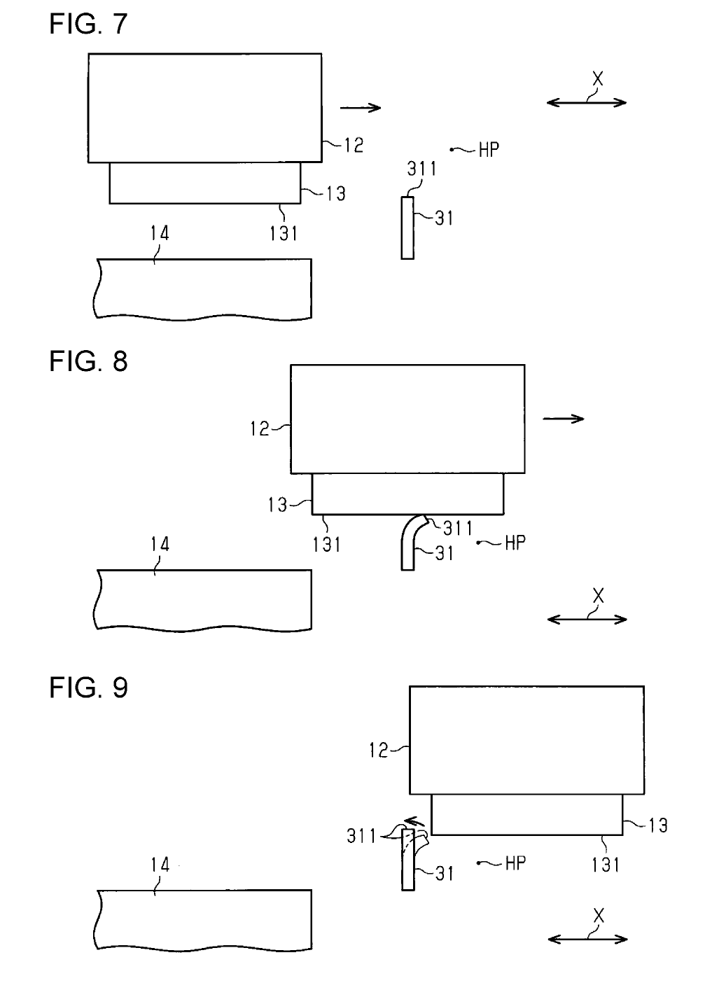

In step S30, the wiping controller 103 sets the wiping flag FLG2 to OFF. After this, the wiping controller 103 ends the processing routine. Next, with reference to FIGS. 7 to 9, the first wiping processing will be described.

As illustrated in FIG. 7, in a situation where the wiping member 31 is disposed at the wiping position, the wiping controller 103 starts the first wiping processing in a state where the recording head 13 is positioned further on a side opposite to the home position HP (that is, on the medium supporting portion 14 side) in the main scanning direction X (wiping direction) than the wiping member 31. In addition, the wiping controller 103 moves the recording head 13 to the home position HP side in the main scanning direction X by the operation of the carriage moving device 50. Accordingly, as illustrated in FIG. 8, the upper end portion 311 of the wiping member 31 comes into contact with the nozzle forming surface 131 of the recording head 13. After this, when the recording head 13 passes through the wiping member 31 and the recording head 13 is positioned on the side opposite to the medium supporting portion 14 in the main scanning direction X from the wiping member 31 as illustrated in FIG. 9, the wiping member 31 is separated from the nozzle forming surface 131 in the main scanning direction X, and thus, the wiping controller 103 stops the movement of the recording head 13 by controlling the operation of the carriage moving device 50. In other words, the first wiping processing is processing for operating the carriage moving device 50 (one of the configuration elements of the moving device) so as to wipe the nozzle forming surface 131 until the wiping member 31 is separated from the nozzle forming surface 131 in the main scanning direction X.

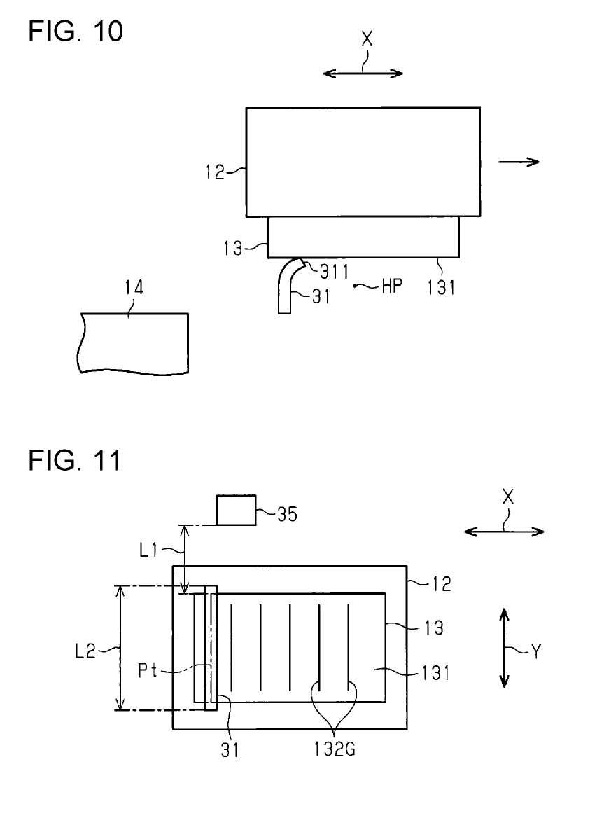

Next, with reference to FIGS. 10 to 13, the second wiping processing will be described.

In a situation where the wiping member 31 is disposed at the wiping position, the wiping controller 103 starts the second wiping processing in a state (refer to FIG. 7) where the recording head 13 is positioned further on a side opposite to the home position HP (that is, on the medium supporting portion 14 side) in the main scanning direction X (wiping direction) than the wiping member 31. In addition, the wiping controller 103 moves the recording head 13 to the home position HP side in the main scanning direction X by the operation of the carriage moving device 50. In addition, as illustrated in FIGS. 10 and 11, when the wiping member 31 comes into contact with a defined position Pt on the nozzle forming surface 131, the wiping controller 103 stops the movement of the recording head 13 in the main scanning direction X by controlling the operation of the carriage moving device 50. In the embodiment, the defined position Pt is set between a nozzle row 132G positioned on the side (the left side in FIG. 11) opposite to the most home position HP in the main scanning direction X among a plurality of nozzle rows 132G arranged in the main scanning direction X, and an edge portion on the side opposite to the home position HP in the main scanning direction X of the nozzle forming surface 131 (the left side edge portion in FIG. 11).

Next, in the second wiping processing, the wiping controller 103 moves the wiping member 31 in the retracting direction Y as illustrated in FIG. 12 by the operation of the wiping device 30. In addition, as illustrated in FIG. 13, when the wiping member 31 is separated from the nozzle forming surface 131 and reaches the retraction position, the wiping controller 103 stops the movement of the wiping member 31 by controlling the operation of the wiping device 30. In other words, in the second wiping processing, after wiping the nozzle forming surface 131 until the wiping member 31 comes into contact with the defined position Pt of the nozzle forming surface 131, the carriage moving device 50 and the wiping device 30 (moving device) are operated such that the wiping member 31 is separated from the nozzle forming surface 131 in the retracting direction Y.

Next, with reference to FIGS. 7 to 13, an action when wiping the nozzle forming surface 131 will be described. In a case where the first wiping processing is performed, as illustrated in FIGS. 7 to 9, with respect to the wiping member 31 disposed at the wiping position, the recording head 13 moves toward the home position HP side from the medium supporting portion 14 side than the wiping member 31 in the main scanning direction X. In addition, as illustrated in FIG. 8, the nozzle forming surface 131 is wiped by bringing the upper end portion 311 of the wiping member 31 into contact with the nozzle forming surface 131. In addition, in a case where the wiping member 31 comes into contact with the nozzle forming surface 131, the wiping member 31 is deflected. In addition, the deflection of the wiping member 31 is eliminated when the wiping member 31 is separated from the nozzle forming surface 131 in the main scanning direction X as illustrated in FIG. 9.

In a case where the second wiping processing is performed, with respect to the wiping member 31 disposed at the wiping position, the recording head 13 moves toward the home position HP side from the medium supporting portion 14 side than the wiping member 31 in the main scanning direction X. In addition, the nozzle forming surface 131 is wiped by moving the recording head 13 in the main scanning direction X in a state where the nozzle forming surface 131 is in contact with the upper end portion 311 of the wiping member 31. When the wiping member 31 comes into contact with the defined position Pt of the nozzle forming surface 131 as illustrated in FIGS. 10 and 11, the movement of the recording head 13 in the main scanning direction X is stopped. In other words, when wiping of the forming part of all of the nozzles 132 on the nozzle forming surface 131 is completed, the movement of the recording head 13 is stopped although the wiping member 31 is still in contact with the nozzle forming surface 131.

After this, in a state where the wiping member 31 is in contact with the defined position Pt of the nozzle forming surface 131 and is still deflected, as illustrated in FIGS. 12 and 13, the wiping member 31 moves toward the retraction position in the retracting direction Y. In a case where the wiping member 31 moves in the retracting direction Y in this manner, in the wiping member 31, the deflection of the part that does not come into contact with the nozzle forming surface 131 is gradually eliminated. In a case where a part of the wiping member 31 is still in contact with the nozzle forming surface 131 in this manner, a force which suppresses elimination of deflection acts on a part that does not come into contact with the nozzle forming surface 131 in the wiping member 31. Therefore, compared to a case where the contact between the wiping member 31 and the nozzle forming surface 131 is eliminated all at once similar to a case of the first wiping processing, the deflection of the wiping member 31 is smoothly eliminated.

In addition, as illustrated in FIG. 12, in a case where the wiping member 31 moves toward the retraction position, at a stage where the wiping member 31 is still in contact with the nozzle forming surface 131, the removing member 35 comes into contact with the wiping member 31. Therefore, by using the movement of the wiping member 31 to the retraction position, removal of the adhering material, such as ink, from the wiping member 31 by the removing member 35 is performed.

Above, according to the embodiment, the following effects can be obtained.

(1) In the embodiment, when wiping the nozzle forming surface 131, any one of the first wiping processing and the second wiping processing is selected. Therefore, by selecting the wiping processing in accordance with the situation at this time, it is possible to wipe the nozzle forming surface 131 in accordance with the situation at this time.

(2) In the second wiping processing, the wiping member 31 is moved in the retracting direction Y at a stage where the wiping member 31 is still in contact with the nozzle forming surface 131. In other words, by moving the wiping member 31 in the retracting direction Y, the wiping member 31 is separated from the nozzle forming surface 131. Therefore, when separating the wiping member 31 from the nozzle forming surface 131, deflection of the wiping member 31 is smoothly eliminated compared to a case where the first wiping processing is performed. Accordingly, compared to a case where the first wiping processing is performed, it is possible to reduce the amount of ink scattering from the wiping member 31 due to the elimination of the deflection of the wiping member 31.

(3) In addition, the direction of the relative movement of the wiping member 31 when the wiping member 31 is separated from the nozzle forming surface 131 by the second wiping processing, is different from the direction of the relative movement of the wiping member 31 when separating the wiping member 31 from the nozzle forming surface 131 by the first wiping processing. Therefore, when performing the second wiping processing, the position of the ink scattering from the wiping member 31 is different from the position of the ink scattering from the wiping member 31 and adhering to the inside of the housing 11 when performing the first wiping processing. Therefore, it is also possible to suppress the local contamination of a part in the housing 11.

(4) When performing the second wiping processing, at a stage where the wiping member 31 which moves in the retracting direction Y is in contact with the nozzle forming surface 131, that is, before the wiping member 31 is separated from the nozzle forming surface 131, it is possible to start the removal of the adhering material from the wiping member 31 by the removing member 35. Therefore, compared to a case where the adhering material is removed from the wiping member 31 after the wiping member 31 does not come into contact with the nozzle forming surface 131, the time required for the second wiping processing can be shortened.

In addition, in a case where the adhering material is removed from the wiping member 31 by the removing member 35 after the wiping member 31 is separated in the retracting direction Y from the nozzle forming surface 131, it is necessary to lengthen the distance between the recording head 13 and the removing member 35 in the retracting direction Y. In this case, the size of the housing 11 increases, and eventually, the size of the printer 10 increases. In this regard, in the embodiment, the removing member 35 is disposed at a position at which the removing member 35 can come into contact with the wiping member 31 at a stage where a part of the wiping member 31 is still in contact with the nozzle forming surface 131. In other words, the distance between the recording head 13 and the removing member 35 in the retracting direction Y may not be lengthened. Therefore, it is possible to suppress the increase in size of the printer 10.

(5) In a case where the removing member 35 is brought into contact with the wiping member 31 at a stage where the removing member 35 is still in contact with the nozzle forming surface 131, depending on the disposing position of the removing member 35, it is possible to bring the removing member 35 into contact with a part of which the deflection is not eliminated in the wiping member 31. In this case, it is possible to reduce the amount of ink adhering to the wiping member 31 when the deflection of the wiping member 31 is eliminated. Therefore, it is possible to further enhance the suppression effect of scattering of the ink from the wiping member 31 when performing the second wiping processing.

(6) When the cleaning is performed, there is a possibility that a lot of ink adheres to the nozzle forming surface 131. Therefore, when the nozzle forming surface 131 is wiped after the cleaning is completed, a lot of ink adheres to the wiping member 31. In addition, when the wiping member 31 is separated from the nozzle forming surface 131 in a state where the amount of ink adhering is large, the amount of ink scattering from the wiping member 31 is likely to increase in accordance with elimination of deflection of the wiping member 31. In this regard, in the embodiment, when the cleaning is completed, the second wiping processing is performed. As a result, compared to a case where the first wiping processing is performed after the cleaning is completed, it is possible to make it difficult to scatter the adhering material from the wiping member 31 when the deflection of the wiping member 31 is eliminated, and further, it is possible to make it difficult to contaminate the inside of the housing 11. Therefore, it is possible to wipe the nozzle forming surface 131 in accordance with a situation where the amount of ink adhering to the nozzle forming surface 131 is large.

(7) Meanwhile, when the cleaning is not performed, there is a possibility that the amount of ink adhering to the nozzle forming surface 131 is small. In this case, even when the nozzle forming surface 131 is wiped off, the amount of ink adhering to the wiping member 31 is not large. Therefore, the first wiping processing is performed. As a result, compared to a case where the second wiping processing is performed even when the cleaning is not performed, it is possible to shorten the time required for wiping the nozzle forming surface 131. Therefore, it is possible to wipe the nozzle forming surface 131 in accordance with a situation where the amount of ink adhering to the nozzle forming surface 131 is small.

(8) In the embodiment, when the cleaning is performed, wiping processing is performed even before the cleaning is performed. However, when the elapsed time TM from the end of the last cleaning operation is less than the defined time TMTh, there is a possibility that the viscosity of the ink adhering to the nozzle forming surface 131 is low. When the ink having low viscosity adheres to the wiping member 31, the ink is likely to scatter from the wiping member 31 when the deflection of the wiping member 31 is eliminated. Therefore, the second wiping processing is performed instead of the first wiping processing. Therefore, compared to a case where the first wiping processing is performed when the viscosity of the ink adhering to the nozzle forming surface 131 is low, it is possible to make it difficult to scatter ink from the wiping member 31 when eliminating the deflection of the wiping member 31.

Meanwhile, when the elapsed time TM is equal to or longer than the defined time TMTh, there is a possibility that the viscosity of the ink adhering to the nozzle forming surface 131 is high. In this case, even when the ink adheres to the wiping member 31 by wiping the nozzle forming surface 131, the ink is unlikely to scatter from the wiping member 31 when the deflection of the wiping member 31 is eliminated. Accordingly, when the elapsed time TM is equal to or longer than the defined time TMTh, the first wiping processing is performed instead of the second wiping processing, and thus, the wiping of the nozzle forming surface 131 can be completed early.

Therefore, it is possible to wipe the nozzle forming surface 131 in accordance with the viscosity of the ink adhering to the nozzle forming surface 131.

### Second Embodiment

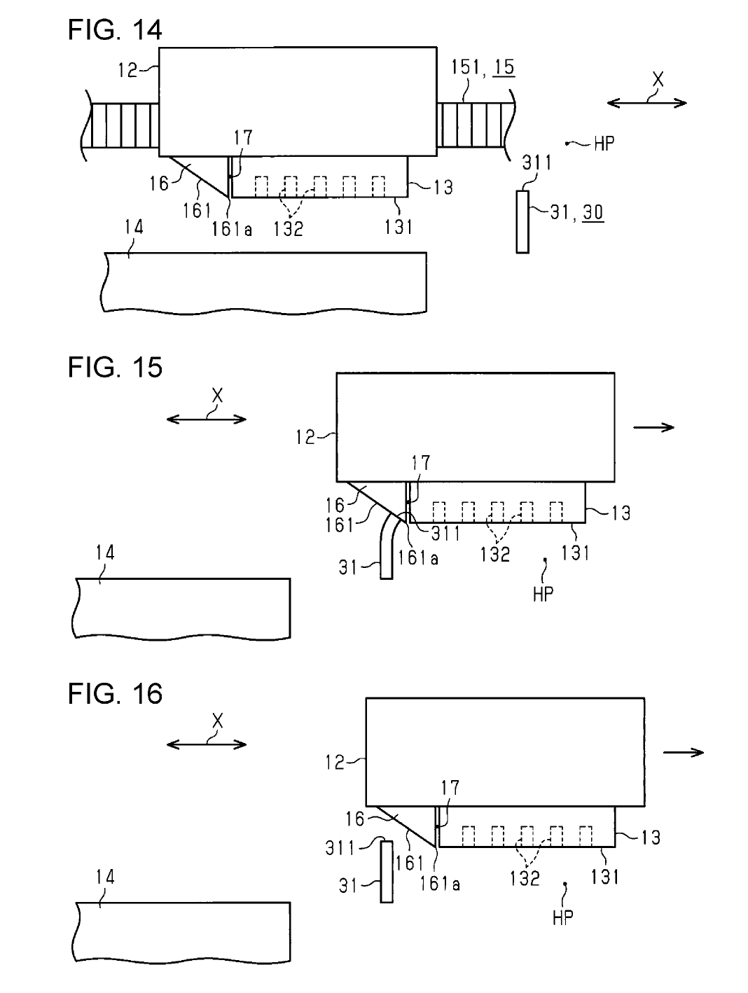

Hereinafter, a second embodiment of the liquid ejecting apparatus will be described with reference to FIGS. 14 to 20. In addition, the second embodiment is different from the first embodiment in a fact that a deflection reducing portion 16 is provided in the carriage 12, the content of the wiping processing by providing the deflection reducing portion 16, and the like. Here, in the following description, parts different from the first embodiment will mainly be described, and the same reference numerals will be given to parts having the same or corresponding configurations, and overlapping description thereof will be omitted.

As illustrated in FIG. 14, the carriage 12 is provided with the deflection reducing portion 16 on the side opposite to the wiping member 31 sandwiching the recording head 13 in the main scanning direction X. In the example illustrated in FIG. 14, by moving the recording head 13 from the medium supporting portion 14 side (left side in FIG. 14) to the home position HP side (right side in FIG. 14) in the main scanning direction X, it is possible to wipe the nozzle forming surface 131 by the wiping member 31. In other words, by relatively moving the wiping member 31 with respect to the recording head 13 in the leftward direction in the drawing, it is possible to wipe the nozzle forming surface 131. In other words, in FIG. 14, in the leftward-and-rightward direction, the right side corresponds to the upstream side in the wiping direction and the left side corresponds to the downstream side in the wiping direction. Therefore, in the embodiment, the deflection reducing portion 16 is disposed on the downstream side from the recording head 13 in the wiping direction.

In the main scanning direction X, the deflection reducing portion 16 has an inclined surface 161 that gradually inclines vertically upward (that is, being separated from the medium supporting portion 14) as being separated from the recording head 13. In a case where the direction orthogonal to the nozzle forming surface 131 is defined as the upward-and-downward direction, the position in the upward-and-downward direction of an end on a side near the recording head 13 on the inclined surface 161 is equal to the position in the upward-and-downward direction of the nozzle forming surface 131. In addition, the position in the upward-and-downward direction at the end on the side near the recording head 13 on the inclined surface 161 may be substantially equal to the position in the upward-and-downward direction of the nozzle forming surface 131, and may be slightly different from the position in the upward-and-downward direction of the nozzle forming surface 131.

In addition, between the recording head 13 and the deflection reducing portion 16 in the main scanning direction X, a holding groove 17 which is capable of holding liquid, such as ink, is provided. The width of the holding groove 17, which is the length of the holding groove 17 in the main scanning direction X, is set to a width with which the liquid, such as ink, can be held by a capillary force, and the ink that flows toward a lower end 161a on the inclined surface 161, it is possible to hold in the holding groove 17 by the capillary force.

Next, with reference to FIGS. 14 to 16, the first wiping processing will be described.

In a situation where the wiping member 31 is disposed at the wiping position, the wiping controller 103 starts the first wiping processing in a state (refer to FIG. 14) where the recording head 13 is positioned on the medium supporting portion 14 side in the main scanning direction X (wiping direction) from the wiping member 31. In addition, the wiping controller 103 moves the recording head 13 from the medium supporting portion 14 side to the home position HP side in the main scanning direction X by the operation of the carriage moving device 50. Accordingly, the upper end portion 311 of the wiping member 31 comes into contact with the nozzle forming surface 131 of the recording head 13. After this, when the recording head 13 passes through the wiping member 31, as illustrated in FIG. 15, the wiping member 31 is separated from the nozzle forming surface 131 in the main scanning direction X, but the upper end portion 311 of the wiping member 31 comes into contact with the inclined surface 161 of the deflection reducing portion 16. In addition, when the upper end portion 311 is separated from the inclined surface 161, and the wiping member 31 is positioned on the side opposite to the recording head 13 sandwiching the deflection reducing portion 16 in the main scanning direction X as illustrated in FIG. 16, the wiping controller 103 stops the movement of the recording head 13 by controlling the operation of the carriage moving device 50. In other words, in the embodiment, the first wiping processing is processing for operating the carriage moving device 50 (one of the configuration elements of the moving device) such that the wiping member 31 comes into contact with the deflection reducing portion 16 after wiping the nozzle forming surface 131, and after this, the wiping member 31 is separated in the main scanning direction X (wiping direction) from the deflection reducing portion 16.

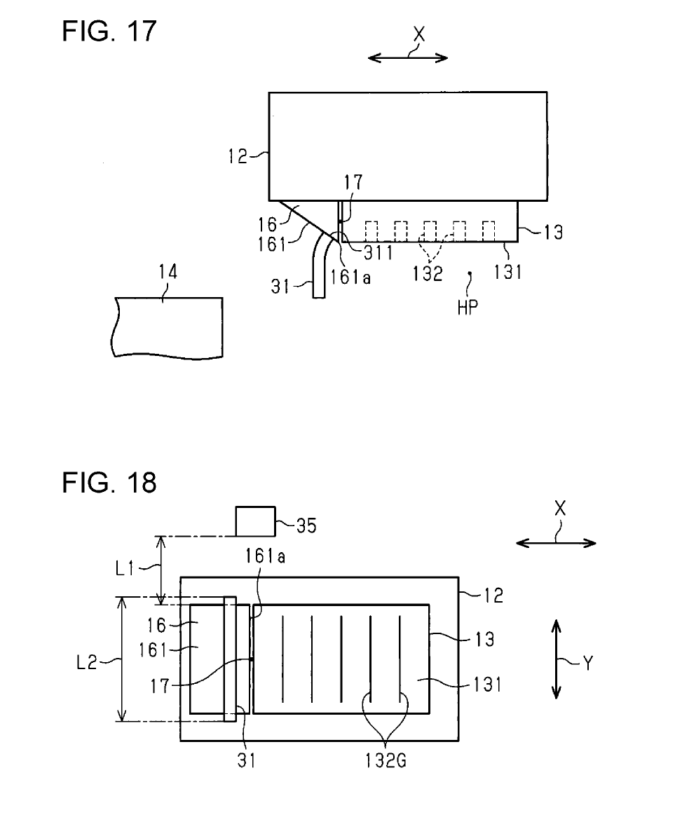

Next, with reference to FIGS. 17 to 20, the second wiping processing will be described.

In a situation where the wiping member 31 is disposed at the wiping position, the wiping controller 103 starts the second wiping processing in a state (refer to FIG. 14) where the recording head 13 is positioned on the medium supporting portion 14 side in the main scanning direction X (wiping direction) from the wiping member 31. In addition, the wiping controller 103 moves the recording head 13 from the medium supporting portion 14 side to the home position HP side in the main scanning direction X by the operation of the carriage moving device 50. Accordingly, the upper end portion 311 of the wiping member 31 comes into contact with the nozzle forming surface 131 of the recording head 13. After this, when the recording head 13 passes through the wiping member 31, as illustrated in FIGS. 17 and 18, the wiping member 31 is separated from the nozzle forming surface 131 in the main scanning direction X, but the upper end portion 311 of the wiping member 31 comes into contact with the inclined surface 161 of the deflection reducing portion 16. In a state where the upper end portion 311 is in contact with the inclined surface 161 and the wiping member 31 is deflected in this manner, the wiping controller 103 stops the movement of the recording head 13 in the main scanning direction X by controlling the operation of the carriage moving device 50.

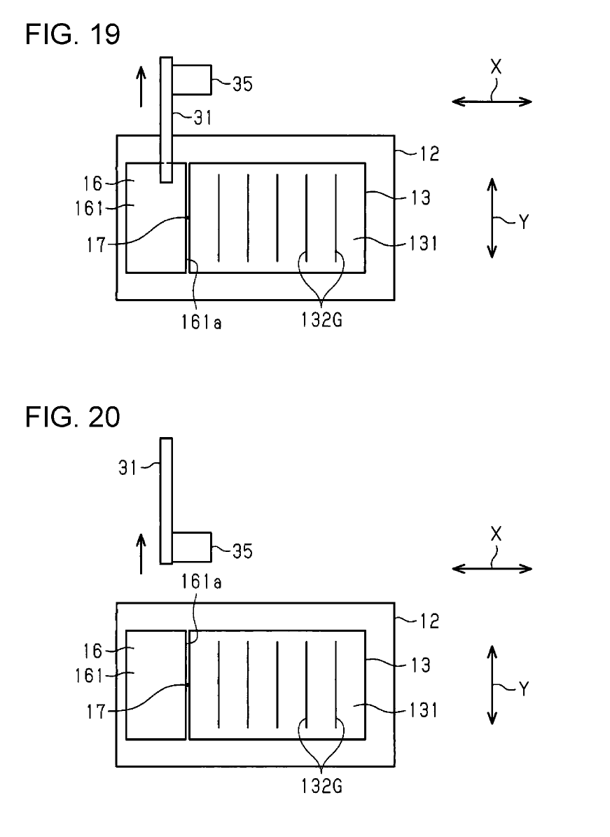

Next, the wiping controller 103 moves the wiping member 31 in the retracting direction Y as illustrated in FIG. 19 by the operation of the wiping device 30. In addition, as illustrated in FIG. 20, when the wiping member 31 is separated from the nozzle forming surface 131 and reaches the retraction position, the wiping controller 103 stops the movement of the wiping member 31 by controlling the operation of the wiping device 30. In other words, the second wiping processing is processing for operating the carriage moving device 50 and the wiping device 30 (moving device) such that the wiping member 31 is separated from the deflection reducing portion 16 in the retracting direction Y after the wiping member 31 wipes the nozzle forming surface 131 and comes into contact with the deflection reducing portion 16.

Next, with reference to FIGS. 14 to 20, an action when wiping the nozzle forming surface 131 will be described.

In a case where the first wiping processing is performed, with respect to the wiping member 31 disposed at the wiping position, the recording head 13 moves toward the home position HP side from the medium supporting portion 14 side than the wiping member 31 in the main scanning direction X. In addition, the nozzle forming surface 131 is wiped by bringing the wiping member 31 into contact with the nozzle forming surface 131. In addition, in a case where the wiping member 31 comes into contact with the nozzle forming surface 131, the wiping member 31 is deflected.

In addition, when the wiping member 31 is separated from the nozzle forming surface 131 in the main scanning direction X, the upper end portion 311 of the wiping member 31 comes into contact with the inclined surface 161 of the deflection reducing portion 16 as illustrated in FIG. 15. Then, due to the movement of the recording head 13 in the main scanning direction X, the deflection amount of the wiping member 31 gradually decreases. In addition, when the upper end portion 311 is separated from the inclined surface 161 in the main scanning direction X, the deflection of the wiping member 31 is eliminated as illustrated in FIG. 16. After this, the movement of the recording head 13 in the main scanning direction X is stopped.

In a case where the second wiping processing is performed, with respect to the wiping member 31 disposed at the wiping position, the recording head 13 moves toward the home position HP side from the medium supporting portion 14 side than the wiping member 31 in the main scanning direction X. In addition, the nozzle forming surface 131 is wiped by moving the recording head 13 in the main scanning direction X in a state where the nozzle forming surface 131 is in contact with the upper end portion 311 of the wiping member 31.

In addition, when the wiping member 31 is separated from the nozzle forming surface 131 in the main scanning direction X, the upper end portion 311 of the wiping member 31 comes into contact with the inclined surface 161 of the deflection reducing portion 16. Then, due to the movement of the recording head 13 in the main scanning direction X, the deflection amount of the wiping member 31 gradually decreases. In the embodiment, the movement of the recording head 13 in the main scanning direction X is stopped in a state in which the upper end portion 311 is still in contact with the inclined surface 161 as illustrated in FIG. 17.

In a state where the wiping member 31 is in contact with the inclined surface 161 in this manner and the wiping member 31 is still deflected, as illustrated in FIG. 19, the wiping member 31 moves toward the retraction position in the retracting direction Y. In a case where the wiping member 31 moves in the retracting direction Y in this manner, in the wiping member 31, the deflection of the part that does not come into contact with the inclined surface 161 is gradually eliminated. In a case where a part of the wiping member 31 is still in contact with the inclined surface 161 in this manner, a force which suppresses elimination of deflection acts on a part that does not comes into contact with the inclined surface 161 in the wiping member 31.

In addition, as illustrated in FIG. 19, in a case where the wiping member 31 moves toward the retraction position, at a stage where the wiping member 31 is still in contact with the inclined surface 161, the removing member 35 comes into contact with the wiping member 31. Therefore, by using the movement of the wiping member 31 to the retraction position, removal of the adhering material, such as ink, from the wiping member 31 by the removing member 35 is performed.

After this, as illustrated in FIG. 20, when the wiping member 31 is separated from the deflection reducing portion 16 in the retracting direction Y and the wiping member 31 moves to the retraction position, the movement of the wiping member 31 is stopped. Above, according to the embodiment, in addition to the same effects as (1) and (5) to (8) in the above-described embodiment, the following effects can further be obtained.

(9) When performing the first wiping processing, the upper end portion 311 of the wiping member 31 comes into contact with the inclined surface 161 of the deflection reducing portion 16 after passing through the nozzle forming surface 131. In other words, by bringing the upper end portion 311 of the wiping member 31 into contact with the inclined surface 161 after wiping the nozzle forming surface 131, it is possible to suppress the deflection of the wiping member 31 from being eliminated all at once. Therefore, even at the end of the first wiping processing, it is possible to make it difficult to scatter the adhering material from the wiping member 31.

(10) In the second wiping processing, the wiping member 31 is moved in the retracting direction Y at a stage where the wiping member 31 is still in contact with the inclined surface 161. In other word, by moving the wiping member 31 in the retracting direction Y, the wiping member 31 is separated from the inclined surface 161. Therefore, when separating the wiping member 31 from the inclined surface 161, deflection of the wiping member 31 is smoothly eliminated compared to a case where the first wiping processing is performed. Accordingly, compared to a case where the first wiping processing is performed, it is possible to reduce the amount of ink scattering from the wiping member 31 due to the elimination of the deflection of the wiping member 31.

(11) In addition, the direction of the relative movement of the wiping member 31 when the wiping member 31 is separated from the inclined surface 161 by the second wiping processing, is different from the direction of the relative movement of the wiping member 31 when separating the wiping member 31 from the inclined surface 161 by the first wiping processing. Therefore, when performing the second wiping processing, the position of the ink scattering from the wiping member 31 is different from the position of the ink scattering from the wiping member 31 and adhering to the inside of the housing 11 when performing the first wiping processing. Therefore, it is also possible to suppress the local contamination of a part in the housing 11.

(12) When performing the second wiping processing, at a stage where the wiping member 31 which moves in the retracting direction Y is in contact with the inclined surface 161, it is possible to start the removal of the adhering material from the wiping member 31 by the removing member 35. Therefore, compared to a case where the adhering material is removed from the wiping member 31 after the wiping member 31 is completely separated from the inclined surface 161, the time required for the second wiping processing can be shortened.

In addition, in a case where the adhering material is removed from the wiping member 31 by the removing member 35 after the wiping member 31 is separated in the retracting direction Y from the inclined surface 161, it is necessary to lengthen the distance between the recording head 13 and the removing member 35 in the retracting direction Y. In this case, the size of the housing 11 increases, and eventually, the size of the printer 10 increases. In this regard, in the embodiment, the removing member 35 is disposed at a position at which the removing member 35 can come into contact with the wiping member 31 at a stage where a part of the upper end portion 311 of the wiping member 31 is still in contact with the inclined surface 161. Therefore, it is possible to suppress the increase in size of the printer 10.

(13) As the wiping member 31 comes into contact with the inclined surface 161, there is a case where the ink adhering to the wiping member 31 adheres to the inclined surface 161. The ink adhering to the inclined surface 161 moves toward the lower end 161a of the inclined surface 161. In addition, the ink that has reached the lower end 161a is held in the holding groove 17 between the deflection reducing portion 16 and the recording head 13 by a capillary force. Since the ink is held in the holding groove 17 in this manner, it is possible to suppress adhesion of the ink to the medium M after performing the wiping processing.

(14) In the second wiping processing performed in the embodiment, after the wiping member 31 is separated from the nozzle forming surface 131 in the main scanning direction X, the wiping member 31 is moved in the retracting direction Y. Therefore, unlike the second wiping processing of the first embodiment, the entire nozzle forming surface 131 can be wiped. Therefore, it is possible to reduce the amount of ink remaining on the nozzle forming surface 131 after the completion of wiping.

In addition, each of the above-described embodiments may be modified as follows.

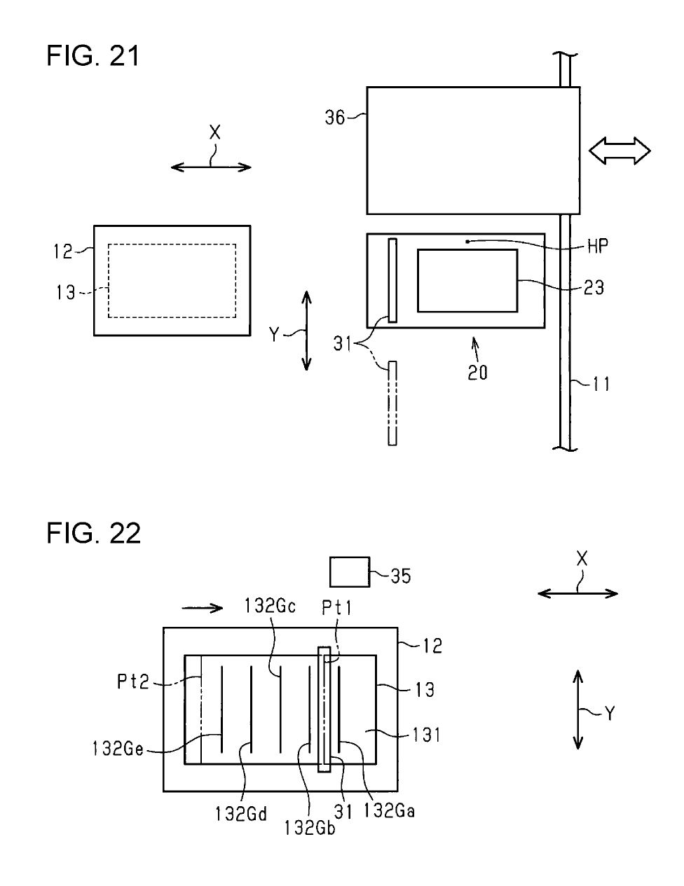

In the printer 10, a waste liquid recovery tank for recovering waste ink recovered by the maintenance device 20 may be provided in an attachable and detachable state. There is a case where the waste liquid recovery tank is disposed near the maintenance device 20. In addition, as illustrated in FIG. 21, in a case where the waste liquid recovery tank 36 is provided on one side (upper side in the drawing) in the retracting direction Y of the maintenance device 20, in the second wiping processing, as illustrated by a two-dot chain line in FIG. 21, by moving the wiping member 31 to the other side (lower side in the drawing) in the retracting direction Y, the wiping member 31 may be separated from the nozzle forming surface 131 or the inclined surface 161. Accordingly, it is possible to suppress the ink scattering from the wiping member 31 from adhering to the waste liquid recovery tank 36 by the elimination of the deflection of the wiping member 31 that moves in the retracting direction Y. Therefore, in a case where the waste liquid recovery tank 36 is detached from the housing 11, it is possible to suppress adhesion of ink to the hand of a user.

There is a case where connection portions of various wirings are disposed near the maintenance device 20 in the housing 11. For example, in a case where the connection portion is provided on one side in the retracting direction Y of the maintenance device 20, in the second wiping processing, by moving the wiping member 31 to the other side in the retracting direction Y, the wiping member 31 may be separated from the nozzle forming surface 131 or the inclined surface 161. Accordingly, it is possible to suppress the ink scattering from the wiping member 31 from adhering to the connection portion by the elimination of the deflection of the wiping member 31 that moves in the retracting direction Y.

The removing member 35 may be disposed at a position at which the upper end portion 311 comes into contact with the wiping member 31 after being separated from the nozzle forming surface 131 or the inclined surface 161 in the retracting direction Y.

The removing member 35 may not be provided.

In the second embodiment, when it is possible to reduce the deflection amount of the wiping member 31 when the wiping member 31 comes into contact with the deflection reducing portion 16 to be smaller than the deflection amount of the wiping member 31 when the wiping member 31 comes into contact with the nozzle forming surface 131, the deflection reducing portion 16 may be of any shape. For example, the deflection reducing portion 16 may have a contact surface parallel to the nozzle forming surface 131. In this case, by disposing the contact surface at a position farther from the wiping member 31 than the nozzle forming surface 131 in the upward-and-downward direction which is the direction orthogonal to the nozzle forming surface 131, it is possible to reduce the deflection amount of the wiping member 31 when the wiping member 31 is in contact with the contact surface to be smaller than the deflection amount of the wiping member 31 when the wiping member 31 is in contact with the nozzle forming surface 131.

In a case where the wiping the nozzle forming surface 131 is performed before the cleaning, the first wiping processing may be performed regardless of whether or not the elapsed time TM is equal to longer than the defined time TMTh.

Even in a case of wiping the nozzle forming surface 131 in a situation where the cleaning is not performed, the first wiping processing is performed when the elapsed time TM is equal to or longer than the defined time TMTh, and the second wiping processing may be performed when the elapsed time TM is less than the defined time TMTh.

In the second embodiment, the holding groove 17 may not be provided between the recording head 13 and the deflection reducing portion 16. In other words, the deflection reducing portion 16 may be in contact with the recording head 13.

An extending direction of the wiping member 31 may not be identical to the retracting direction Y. For example, the retracting direction Y may be a direction along the nozzle forming surface 131 and may also be a direction intersecting with both of the extending direction and the wiping direction of the wiping member 31.

In addition, the retracting direction Y may be a rotation direction around an axial line that extends in the direction orthogonal to the nozzle forming surface 131. In this case, even when the wiping member 31 is moved in the retracting direction Y, the nozzle forming surface 131 or the inclined surface 161 can be wiped. In other words, it is possible to reduce the amount of ink remaining on the nozzle forming surface 131 or the inclined surface 161 after performing the second wiping processing.

In each of the above-described embodiments, in a case of wiping the nozzle forming surface 131, the recording head 13 is moved in the main scanning direction X in a state where the wiping member 31 is fixed at the wiping position. However, the nozzle forming surface 131 may be wiped by moving the wiping member 31 in the main scanning direction without moving the recording head 13.

In addition, in a case where the wiping member 31 is separated from the nozzle forming surface 131 in the retracting direction Y when the performing the second wiping processing, the wiping member 31 may be separated from the nozzle forming surface 131 in the retracting direction Y by moving the recording head 13 in the retracting direction Y without moving the wiping member 31.

In a case of wiping the nozzle forming surface 131 by moving the wiping member 31 without moving the recording head 13, the device for moving the wiping member 31 corresponds to an example of the “moving device”.

In a case of wiping the nozzle forming surface 131 by moving the recording head 13 without moving the recording head 13, the device for moving the wiping member 31 corresponds to an example of the “moving device”.

The recording head 13 may include the nozzle 132 which ejects pigment ink and the nozzle 132 which ejects dye ink. In this case, on the nozzle forming surface 131, the wiping may be performed separately in a region where the nozzle 132 which ejects the pigment ink is opened and a region where the nozzle 132 which ejects the dye ink is opened.

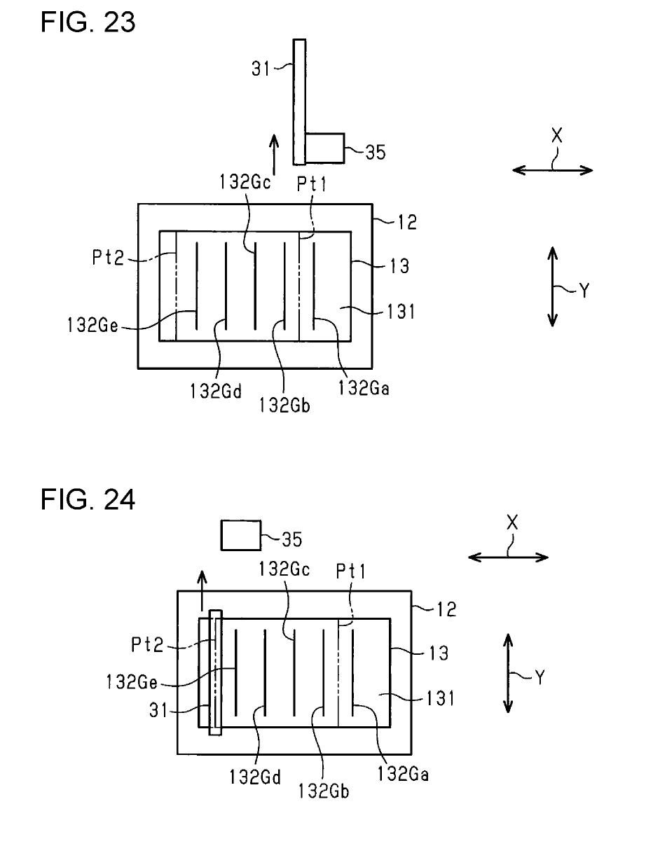

In FIGS. 22 and 23, an example of a case of wiping the nozzle forming surface 131 of the recording head 13 including the nozzle 132 which ejects the pigment ink and the nozzle 132 which ejects the dye ink, is illustrated. In FIGS. 22 and 23, among the nozzle rows 132G, the nozzle row positioned on the rightmost side in the drawing is a pigment nozzle row 132Ga configured of the nozzles 132 which eject the pigment ink. In addition, among each of the nozzle rows 132G, each of nozzle rows other than the pigment nozzle row 132Ga is dye nozzle rows 132Gb, 132Gc, 132Gd, and 132Ge configured of the nozzle 132 which ejects the dye ink.

In the example, a first defined position Pt1 is set between the pigment nozzle row 132Ga and the dye nozzle row 132Gb in the main scanning direction X, and a second defined position Pt2 is set between the dye nozzle row 132Ge and the edge portion on the side separated from the pigment nozzle row 132Ga, are set. Therefore, in a case of wiping the nozzle forming surface 131, the second wiping processing is performed first. In other words, as illustrated in FIG. 22, when the recording head 13 moves in the main scanning direction X until the wiping member 31 comes into contact with the first defined position Pt1 of the nozzle forming surface 131, the movement of the recording head 13 in the main scanning direction X is stopped. In this state, as illustrated in FIG. 23, the wiping member 31 disposed at the wiping position moves in the retracting direction Y toward the retraction position. In this case, since the removing member 35 comes into contact with the wiping member 31 when the wiping member 31 is moving in the retracting direction Y, the adhering material, such as ink, is removed from the wiping member 31.

In addition, when the wiping member 31 reaches the retraction position, the recording head 13 is moved to the position when starting the wiping of the nozzle forming surface 131. After this, the second wiping processing is started after moving the wiping member 31 to the wiping position. In the second wiping processing in this case, when the recording head 13 moves in the main scanning direction X until the wiping member 31 comes into contact with the second defined position Pt2 of the nozzle forming surface 131, the movement of the recording head 13 in the main scanning direction X is stopped. In this state, as illustrated in FIG. 24, the wiping member 31 moves in the retracting direction Y toward the retraction position. In this case, since the removing member 35 comes into contact with the wiping member 31 when the wiping member 31 is moving in the retracting direction Y, the adhering material, such as ink, is removed from the wiping member 31.

Accordingly, on the nozzle forming surface 131, before wiping the region where each of the nozzles 132 which eject the dye ink is opened, it is possible to reduce the amount of the pigment ink adhering to the nozzle forming surface 131. Therefore, on the nozzle forming surface 131, when wiping the region where each of the nozzles 132 which eject the dye ink is opened, it is possible to suppress mixing of the pigment ink and the dye ink.

In addition, on the nozzle forming surface 131, after wiping the region where each of the nozzles 132 which eject the dye ink is opened by the second wiping processing, the first wiping processing may be performed to wipe the entire nozzle forming surface 131. In addition, after performing the cleaning, the second wiping processing may be performed, and in a case where the cleaning is not performed, the first wiping processing may be performed.

As the printer 10, there is a printer having a function of detecting ejection failure of ink from the nozzle 132. In the printer 10, when the ejection failure of ink from the nozzle 132 is detected due to the foreign matters, such as paper dust that flows into the nozzle 132, the first wiping processing may be selected and performed. Meanwhile, when bubbles that exist in the nozzle 132 and the ejection failure of ink from the nozzle 132 due to thickening of the ink in the nozzle 132 are detected, the second wiping processing may be selected and performed.

In addition, as the function, for example, a function of driving a driving element (for example, a piezoelectric element) which operates to eject ink from the nozzle 132 to the extent that the ink is not ejected from the nozzle 132, and based on residual vibration of a cavity, determining whether or not foreign matters are mixed in the nozzle 132, whether or not the bubbles exist in the nozzle 132, and whether or not the ink in the nozzle 132 increases in viscosity, can be employed.

The liquid discharge processing may be processing other than the cleaning as long as the processing is not the ejection of ink from the nozzle 132 toward the medium M. For example, the liquid discharge processing may be flushing in which the ink is ejected from each of the nozzles 132 into the cap 23 or an ink receiving unit. In this case, the cap 23 or the ink receiving unit for receiving the ink ejected from each of the nozzles 132 when performing flushing, function as an example of “liquid discharge processing unit”.

When the direction of the relative movement of the wiping member 31 with respect to the recording head 13 when separating the wiping member 31 from the nozzle forming surface 131 or the inclined surface 161 by the second wiping processing is a direction intersecting with the main scanning direction X (that is, the wiping direction), the direction may be a direction intersecting with the nozzle forming surface 131. In this case, in the middle of performing the second wiping processing, by moving the removing member 35 when separating the wiping member 31 from the nozzle forming surface 131 or the inclined surface 161, and by bringing the removing member 35 into contact with the wiping member 31 before the removing member 35 is separated from the nozzle forming surface 131 or the inclined surface 161, the adhering material is removed from the wiping member 31.

The printer is not a serial type described in the above-described embodiment but may be a lateral type in which the carriage can move in two directions of the main scanning direction and the transport direction of the medium, or a liquid ejecting head may be a line type that extends in the width direction of the medium.

In the above-described embodiment, the liquid ejecting apparatus may be a liquid ejecting apparatus which ejects or discharges liquid other than the ink. In addition, examples of a state of the liquid discharged as a minute amount of liquid droplets from the liquid ejecting apparatus include grain, teardrop, thread-like tails. In addition, the liquid referred here may be any material as long as the liquid can be ejected from the liquid ejecting apparatus. For example, any state may be employed as long as the substance is in a liquid phase, and a fluid body, such as a liquid material having high or low viscosity, sol, gel water, other inorganic solvent, organic solvent, solution, liquid resin, or liquid metal (metallic melt) may be employed. In addition, not only a liquid as one state of a substance but also a substance in which particles of a functional material composed of a solid material, such as a pigment and metal particles are dissolved, dispersed or mixed in a solvent, and the like are also included. Representative examples of the liquid include ink, liquid crystal, and the like as described in the above embodiment. Here, the ink includes various types of liquid compositions, such as general water-based ink and oil-based ink, gel ink, hot melt ink and the like. A specific example of the liquid ejecting apparatus includes a liquid ejecting apparatus which ejects the liquid containing dispersed or dissolved materials, such as electrode materials or coloring materials used for manufacturing liquid crystal displays, electroluminescence (EL) displays, surface emitting displays, or color filters. In addition, the liquid ejecting apparatus may be a liquid ejecting apparatus which ejects a bioorganic material used for biochip production, a liquid ejecting apparatus which ejects a liquid that serves as a sample used as a precision pipette, a textile printing apparatus, a micro dispenser, or the like. Furthermore, the liquid ejecting apparatus may be a liquid ejecting apparatus which ejects lubricating oil pinpointing to a precision machine, such as a timepiece or a camera, or a liquid ejecting apparatus which ejects a transparent resin liquid, such as an ultraviolet curing resin, onto the substrate for forming a micro hemispherical lens (optical lens) used for an optical communication element or the like. In addition, the liquid ejecting apparatus may be a liquid ejecting apparatus which ejects an etching solution, such as acid or alkali to etch a substrate or the like.

Hereinafter, the technical idea grasped from the embodiment and the modification examples described above and the effects thereof will be described.

### Idea 1

A liquid ejecting apparatus including: a liquid ejecting head having a nozzle which ejects a liquid and a nozzle forming surface on which the nozzle is opened; a wiping portion which wipes the nozzle forming surface by relatively moving in a wiping direction which is a direction along the nozzle forming surface with respect to the liquid ejecting head; a moving device which moves at least one of the liquid ejecting head and the wiping portion; and a wiping controller which controls the moving device, in which the wiping controller selects and performs at least one of first wiping processing for operating the moving device so as to wipe the nozzle forming surface until the wiping portion is separated from the nozzle forming surface in the wiping direction, and second wiping processing for operating the moving device so as to separate the wiping portion from the nozzle forming surface in a retracting direction which is a direction different from the wiping direction after wiping the nozzle forming surface until the wiping portion comes into contact with the nozzle forming surface at a defined position.

In the above-described configuration, plural types of wiping processing having a different aspect of the relative movement of the wiping portion with respect to the liquid ejecting head are prepared, and any one wiping processing is selected and performed from each wiping processing. Therefore, by selecting the wiping processing in accordance with the situation at this time, it is possible to wipe the nozzle forming surface in accordance with the situation at this time.

### Idea 2

The liquid ejecting apparatus according to “Idea 1”, in which the retracting direction is a direction along the nozzle forming surface and is different from the wiping direction.

In a situation where the nozzle forming surface is wiped by relatively moving the wiping portion with respect to the liquid ejecting head in the wiping direction, in the wiping portion, the part which comes into contact with the nozzle forming surface is called a contact part. According to the above-described configuration, by relatively moving the wiping portion in the retracting direction when performing the second wiping processing, the region which does not come into contact with the nozzle forming surface gradually increases at the contact part of the wiping portion. Therefore, the deflection of the wiping portion is gradually eliminated, and an event that the deflection of the wiping portion is eliminated all at once is unlikely to be generated. Therefore, when separating the wiping portion from the nozzle forming surface, it is possible to reduce the amount of liquid scattering from the wiping portion in accordance with the elimination of deflection of the wiping portion.

### Idea 3

The liquid ejecting apparatus according to “Idea 1” or “Idea 2”, further including: a removing unit which removes the liquid from the wiping portion by coming into contact with the wiping portion, in which, in the second wiping processing, the removing unit comes into contact with the wiping portion before the wiping portion relatively moves in the retracting direction with respect to the liquid ejecting head and is separated from the nozzle forming surface.

According to the above-described configuration, when performing the second wiping processing, it is possible to remove the liquid from the wiping portion by the removing unit at the stage where the wiping portion is still in contact with the nozzle forming surface. In other words, it is possible to bring the removing unit into contact with the part that is still deflected in the wiping portion, and to remove the liquid from the part. Therefore, it is possible to suppress scattering of liquid from the wiping portion when the deflection of the wiping portion is eliminated.

### Idea 4

A liquid ejecting apparatus including: a liquid ejecting head having a nozzle which ejects a liquid and a nozzle forming surface on which the nozzle is opened; a wiping portion which wipes the nozzle forming surface by relatively moving in a wiping direction which is a direction along the nozzle forming surface with respect to the liquid ejecting head; a deflection reducing portion which is disposed on the downstream side in the wiping direction from the liquid ejecting head, and is configured such that a deflection amount of the wiping portion becomes smaller than that when the wiping portion comes into contact with the nozzle forming surface; and a moving device which moves at least one of the liquid ejecting head and the wiping portion; and a wiping controller which controls the moving device, in which the wiping controller selects and performs at least one of first wiping processing for operating the moving device so as to bring the wiping portion into contact with the deflection reducing portion after wiping the nozzle forming surface, and then separate the wiping portion from the deflection reducing portion in the wiping direction, and second wiping processing for operating the moving device so as to separate the wiping portion from the deflection reducing portion in a retracting direction which is a direction along the nozzle forming surface and is different from the wiping direction after the wiping portion wipes the nozzle forming surface and comes into contact with the deflection reducing portion.

In the above-described configuration, plural types of wiping processing having a different aspect of the relative movement of the wiping portion with respect to the liquid ejecting head are prepared, and any one wiping processing is selected and performed from each wiping processing. Therefore, by selecting the wiping processing in accordance with the situation at this time, it is possible to wipe the nozzle forming surface in accordance with the situation at this time.

In addition, when performing the first wiping processing, the wiping portion comes into contact with the deflection reducing portion after wiping the nozzle forming surface. The deflection amount of the wiping portion in a case where the wiping portion is in contact with the deflection reducing portion is less than the deflection amount of the wiping portion in a case where the wiping portion is in contact with the nozzle forming surface. Therefore, it is possible to make it difficult to scatter liquid from the wiping portion when nothing is in contact with the contact part of the wiping portion and the deflection of the wiping portion is eliminated.

When performing the second wiping processing, by relatively moving the wiping portion in the retracting direction, the region which does not come into contact with the deflection reducing portion gradually increases at the contact part of the wiping portion. Therefore, the deflection of the wiping portion is gradually eliminated, and an event that the deflection of the wiping portion is eliminated all at once is unlikely to be generated. Therefore, at the end of the second wiping processing, it is possible to make it difficult to scatter liquid from the wiping portion.

### Idea 5

The liquid ejecting apparatus according to “Idea 4”, in which the deflection reducing portion has an inclined surface which is inclined so as to be gradually positioned higher as being separated from the liquid ejecting head in the wiping direction, and a holding groove which is capable of holding the liquid between the liquid ejecting head and the deflection reducing portion in the wiping direction.

According to the above-described configuration, by bringing the inclined surface into contact with the wiping portion which relatively moves in the wiping direction, the deflection amount of the wiping portion can be gradually reduced.

In addition, when performing the second wiping processing, the relative movement of the wiping portion in the retracting direction is started in a state where the wiping portion is in contact with the inclined surface, and thus, there is a case where a part of the liquid adhering to the wiping portion adheres to the inclined surface. In this respect, in the above-described configuration, a holding groove is provided between the deflection reducing portion and the liquid ejecting head. Therefore, the liquid adhering to the inclined surface moves toward the lower end of the inclined surface, and when the liquid reaches the lower end, the liquid is held in the holding groove by the capillary force. Therefore, after performing the wiping processing, it is possible to suppress the flowing down of the liquid adhering to the inclined surface.

### Idea 6

The liquid ejecting apparatus according to “Idea 4” or “Idea 5”, further including: a removing unit which removes the liquid adhering to the wiping portion by coming into contact with the wiping portion, in which, in the second wiping processing, the removing unit comes into contact with the wiping portion before the wiping portion relatively moves in the retracting direction with respect to the liquid ejecting head and is separated from the deflection reducing portion.

According to the above-described configuration, when performing the second wiping processing, it is possible to remove the liquid from the wiping portion by the removing unit at the stage where the wiping portion is still in contact with the deflection reducing portion. In other words, it is possible to bring the removing unit into contact with the part that is still deflected in the wiping portion, and to remove the liquid from the part. Therefore, it is possible to suppress scattering of liquid from the wiping portion when the deflection of the wiping portion is eliminated.

### Idea 7

The liquid ejecting apparatus according to any one of “Idea 1” to “Idea 6”, further including: a liquid discharge processing unit which is used when liquid discharge processing for discharging the liquid from the nozzle of the liquid ejecting head is performed, in which the wiping controller selects and performs the second wiping processing when the liquid discharge processing is performed, and selects and performs the first wiping processing when the liquid discharge processing is not performed.

When the liquid discharge processing is performed, a lot of liquid may adhere to the nozzle forming surface. In this case, by wiping the nozzle forming surface, a lot of liquid adheres to the wiping portion. Therefore, when liquid discharge processing is performed, a second wiping processing is performed. As a result, even in a case where a lot of liquid adheres to the wiping portion, it is possible to make it difficult to scatter liquid from the wiping portion when the deflection of the wiping portion is eliminated.

Meanwhile, when the liquid discharge processing is not performed, there is a possibility that the amount of liquid adhering to the nozzle forming surface is small. In this case, since a lot of liquid does not adhere to the wiping portion even when wiping the nozzle forming surface, when the deflection of the wiping portion is eliminated, liquid is not likely to scatter from the wiping portion in the first place. Therefore, the first wiping processing is performed. Therefore, compared to a case where the second wiping processing is performed even when the liquid discharge processing is not performed, the time required for wiping the nozzle forming surface can be shortened.

### Idea 8

The liquid ejecting apparatus according to any one of “Idea 1” to “Idea 6”, further including: a liquid discharge processing unit which is used when the liquid discharge processing for discharging the liquid from the nozzle of the liquid ejecting head is performed, in which, when the liquid discharge processing is performed, the wiping controller selects and performs the first wiping processing in a case of wiping the nozzle forming surface before performing the liquid discharge processing, and selects and performs the second wiping processing in a case of wiping the nozzle forming surface after performing the liquid discharge processing, and when the liquid discharge processing is not performed, the wiping controller selects and performs the first wiping processing.

According to the above-described configuration, before the liquid discharge processing is performed, there is a possibility that the amount of liquid adhering to the nozzle forming surface is smaller than that after the liquid discharge processing is performed. In this case, since a lot of liquid does not adhere to the wiping portion even when wiping the nozzle forming surface, when the deflection of the wiping portion is eliminated, liquid is not likely to scatter from the wiping portion in the first place. Therefore, when the nozzle forming surface is wiped before the liquid discharge processing is performed, a first wiping processing is performed. As a result, compared to a case where the second wiping processing is performed even before the liquid discharge processing is performed, the time required for wiping the nozzle forming surface can be shortened, and further, the liquid discharge processing can be started early.

In addition, after the liquid discharge processing is performed, there is a possibility that the amount of liquid adhering to the nozzle forming surface is small. Therefore, when wiping the nozzle forming surface is wiped after the liquid discharge processing is performed, since a lot of liquid adheres to the wiping portion, liquid is easily scattered from the wiping portion when the deflection of the wiping portion is eliminated. Here, according to the above-described configuration, the second wiping processing is performed after the liquid discharge processing is performed. As a result, compared to a case where the first wiping processing is performed, it is possible to make it difficult to scatter liquid from the wiping portion when the deflection of the wiping portion is eliminated.

In addition, when the liquid discharge processing is not performed, there is a possibility that the amount of liquid adhering to the nozzle forming surface is small, and thus, the first wiping processing is performed. Therefore, compared to a case where the second wiping processing is performed even when the liquid discharge processing is not performed, the time required for wiping the nozzle forming surface can be shortened.

Therefore, according to the above-described configuration, wiping processing according to the amount of liquid adhering to the nozzle forming surface can be performed.

### Idea 9

The liquid ejecting apparatus according to “Idea 8”, in which, when the liquid discharge processing is performed, the wiping controller selects and performs the second wiping processing instead of the first wiping processing on a condition that the elapsed time after performing the previous liquid discharge processing in a case of wiping the nozzle forming surface before performing the liquid discharge processing is less than the defined time.

Since the liquid adhering to the nozzle forming surface volatilizes with the lapse of time, the longer the elapsed time since the liquid adheres to the nozzle forming surface, the higher the viscosity of the liquid. In addition, the higher the viscosity of the liquid adhering to the wiping portion by wiping the nozzle forming surface, the more difficult it is to scatter the liquid from the wiping portion when the deflection of the wiping portion is eliminated. In other words, when the elapsed time since the liquid adheres to the nozzle forming surface is short, the viscosity of the liquid is not high, and thus, the liquid is likely to scatter from the wiping portion when the deflection of the wiping portion is eliminated.

In this respect, according to the above-described configuration, in a case of wiping the nozzle forming surface before the liquid discharge processing is performed, when the elapsed time after performing the previous liquid discharge processing is less than the defined time, since there is a possibility that the viscosity of the liquid adhering to the nozzle forming surface is low, the second wiping processing is performed instead of the first wiping processing. Therefore, compared to a case where the first wiping processing is performed when the viscosity of the liquid adhering to the nozzle forming surface is low, it is possible to make it difficult to scatter liquid from the wiping portion when eliminating the deflection of the wiping portion.

### Idea 10

A liquid ejecting apparatus including: a liquid ejecting head having a nozzle which ejects a liquid and a nozzle forming surface on which the nozzle is opened; a wiping portion which wipes the nozzle forming surface by relatively moving in a wiping direction which is a direction along the nozzle forming surface with respect to the liquid ejecting head; a moving device which moves at least one of the liquid ejecting head and the wiping portion; and a wiping controller which controls the moving device, in which the wiping controller performs wiping processing for operating the moving device so as to start the relative movement with respect to the liquid ejecting head of the wiping portion in a retracting direction which is a direction along the nozzle forming surface and is different from the wiping direction in a state where the wiping portion is still deflected after the wiping portion wipes the nozzle forming surface, and then to separate the wiping portion from the liquid ejecting head in the retracting direction.

According to the above-described configuration, by performing the wiping processing when the amount of liquid adhering to the nozzle forming surface is large, even when a lot of liquid adheres to the wiping portion by wiping the nozzle forming surface, it is possible to make it difficult to scatter liquid from the wiping portion when eliminating the deflection of the wiping portion. Therefore, it is possible to wipe the nozzle forming surface in accordance with a situation where the amount of liquid adhering to the nozzle forming surface is large.

### Idea 11

The liquid ejecting apparatus according to “Idea 10”, further including: a removing unit which removes the liquid adhering to the wiping portion by coming into contact with the wiping portion, in which, in the wiping processing, the removing unit comes into contact with the wiping portion before the wiping portion relatively moves in the retracting direction with respect to the liquid ejecting head and the deflection of the wiping portion is eliminated.

According to the above-described configuration, when performing the wiping processing, the liquid can be removed from the wiping portion by the removing unit while the deflection of the wiping portion is being eliminated. In other words, it is possible to bring the removing unit into contact with the part that is still deflected in the wiping portion, and to remove the liquid from the part. Therefore, it is possible to suppress scattering of liquid from the wiping portion when the deflection of the wiping portion is eliminated.

The entire disclosure of Japanese Patent Application No. 2017-093010, filed May 9, 2017 is expressly incorporated by reference herein.

What is claimed is:

1. A liquid ejecting apparatus comprising:
a liquid ejecting head having a nozzle which ejects liquid and a nozzle forming surface on which the nozzle is opened;
a wiping portion which wipes the nozzle forming surface by relatively moving in a wiping direction which is a direction along the nozzle forming surface with respect to the liquid ejecting head;
a moving device which moves at least one of the liquid ejecting head and the wiping portion; and
a wiping controller which controls the moving device,
wherein the wiping controller selects and performs at least one of first wiping processing for operating the moving device to wipe the nozzle forming surface until the wiping portion is separated from the nozzle forming surface in the wiping direction, and second wiping processing for operating the moving device to separate the wiping portion from the nozzle forming surface in a retracting direction which is a direction different from the wiping direction after wiping the nozzle forming surface until the wiping portion comes into contact with a defined position of the nozzle forming surface.

2. The liquid ejecting apparatus according to claim 1,
wherein the retracting direction is a direction along the nozzle forming surface and is different from the wiping direction.

3. The liquid ejecting apparatus according to claim 1, further comprising:
a removing unit which removes the liquid from the wiping portion by coming into contact with the wiping portion,
wherein, in the second wiping processing, the removing unit comes into contact with the wiping portion before the wiping portion relatively moves in the retracting direction with respect to the liquid ejecting head and is separated from the nozzle forming surface.

4. A liquid ejecting apparatus comprising:
a liquid ejecting head having a nozzle which ejects a liquid and a nozzle forming surface on which the nozzle is opened;
a wiping portion which wipes the nozzle forming surface by relatively moving in a wiping direction which is a direction along the nozzle forming surface with respect to the liquid ejecting head;
a deflection reducing portion which is disposed on the downstream side in the wiping direction from the liquid ejecting head, and is configured that a deflection amount of the wiping portion becomes smaller than that when the wiping portion comes into contact with the nozzle forming surface; and
a moving device which moves at least one of the liquid ejecting head and the wiping portion; and
a wiping controller which controls the moving device,
wherein the wiping controller selects and performs at least one of first wiping processing for operating the moving device to bring the wiping portion into contact with the deflection reducing portion after wiping the nozzle forming surface, and then separate the wiping portion from the deflection reducing portion in the wiping direction, and second wiping processing for operating the moving device to separate the wiping portion from the deflection reducing portion in a retracting direction which is a direction along the nozzle forming surface and is different from the wiping direction after the wiping portion wipes the nozzle forming surface and comes into contact with the deflection reducing portion.

5. The liquid ejecting apparatus according to claim 4,
wherein the deflection reducing portion has an inclined surface which is inclined to be gradually positioned higher as being separated from the liquid ejecting head in the wiping direction, and a holding groove which is capable of holding the liquid between the liquid ejecting head and the deflection reducing portion in the wiping direction.

6. The liquid ejecting apparatus according to claim 4, further comprising:
a removing unit which removes the liquid adhering to the wiping portion by coming into contact with the wiping portion,
wherein, in the second wiping processing, the removing unit comes into contact with the wiping portion before the wiping portion relatively moves in the retracting direction with respect to the liquid ejecting head and is separated from the deflection reducing portion.

7. The liquid ejecting apparatus according to claim 1, further comprising:
a liquid discharge processing unit which is used when liquid discharge processing for discharging the liquid from the nozzle of the liquid ejecting head is performed,
wherein the wiping controller selects and performs the second wiping processing when the liquid discharge processing is performed, and selects and performs the first wiping processing when the liquid discharge processing is not performed.

8. The liquid ejecting apparatus according to claim 1, further comprising:
a liquid discharge processing unit which is used when the liquid discharge processing for discharging the liquid from the nozzle of the liquid ejecting head is performed,
wherein, when the liquid discharge processing is performed, the wiping controller selects and performs the first wiping processing in a case of wiping the nozzle forming surface before performing the liquid discharge processing, and selects and performs the second wiping processing in a case of wiping the nozzle forming surface after performing the liquid discharge processing, and when the liquid discharge processing is not performed, the wiping controller selects and performs the first wiping processing.

9. The liquid ejecting apparatus according to claim 8,
wherein, when the liquid discharge processing is performed, the wiping controller selects and performs the second wiping processing instead of the first wiping processing on a condition that the elapsed time after performing the previous liquid discharge processing is less than a defined time in a case of wiping the nozzle forming surface before performing the liquid discharge processing.

10. A liquid ejecting apparatus comprising:
a liquid ejecting head having a nozzle which ejects a liquid and a nozzle forming surface on which the nozzle is opened;
a wiping portion which wipes the nozzle forming surface by relatively moving in a wiping direction which is a direction along the nozzle forming surface with respect to the liquid ejecting head;
a moving device which moves at least one of the liquid ejecting head and the wiping portion; and
a wiping controller which controls the moving device,
wherein the wiping controller performs wiping processing for operating the moving device to start the relative movement with respect to the liquid ejecting head of the wiping portion in a retracting direction which is a direction along the nozzle forming surface and is different from the wiping direction in a state where the wiping portion is still deflected after the wiping portion wipes the nozzle forming surface, and then to separate the wiping portion from the liquid ejecting head in the retracting direction.

11. The liquid ejecting apparatus according to claim 10, further comprising:
a removing unit which removes the liquid adhering to the wiping portion by coming into contact with the wiping portion,
wherein, in the wiping processing, the removing unit comes into contact with the wiping portion before the wiping portion relatively moves in the retracting direction with respect to the liquid ejecting head and the deflection of the wiping portion is eliminated.
